(19) United States
(12) Patent Application Publication
(10) Pub. No.: US 2006/0000542 A1
(43) Pub. Date: Jan. 5, 2006

(54) METAL OXIDE CERAMIC THIN FILM ON BASE METAL ELECTRODE

(76) Inventors: Yongki Min, Phoenix, AZ (US); Cengiz A. Palanduz, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/882,745

(22) Filed: Jun. 30, 2004

(51) Int. Cl. C03B 29/00

(52) U.S. Cl. 156/89.11; 156/89.18; 264/615

(57) ABSTRACT

A method including forming a capacitor structure including an electrode material and a ceramic material on the electrode material; and sintering the ceramic material under a condition where a point defect state of the ceramic material defines the ceramic material as insulating without oxidation of the electrode material. A method including depositing a ceramic material on an electrically conductive foil; and sintering the ceramic material in a reducing atmosphere at a temperature that minimizes the mobility of point defects to transition to a level corresponding to a greater conductivity of the ceramic material. An apparatus including a first electrode; a second electrode; and a ceramic material disposed between the first electrode and the second electrode, wherein the ceramic material includes a thickness less than one micron and a leakage current corresponding to a thermodynamic state wherein a concentration of mobile point defects have been optimized.

### BACKGROUND

1. Field

Integrated circuit structure and packaging.

2. Background

It is desirable to provide decoupling capacitance in a close proximity to an integrated circuit chip or die. The need for such capacitance increases as the switching speed and current requirements of chips or dies becomes higher. One way to provide decoupling capacitance through a chip or die is through an interposer substrate between a chip and a package. Utilizing an interposer substrate between a chip and a package allows capacitance to be approximate to a chip without utilizing real estate on a chip or an associated substrate package. Such configuration tends to improve the capacitance on power supply lines for the chip.

In terms of an interposer substrate, capacitance may be provided through the use of thin film capacitors. Representatively, a platinum material in the form of patterned sheets may form the electrodes and a dielectric material (e.g., metal oxide materials) may be formed between the electrodes. Platinum as a material for the electrode will not oxidize at high processing temperatures in air, such as temperatures that might be used to sinter ceramic dielectric. Platinum, however, has a relatively high raw material cost and a high electrical resistivity compared to the cost and resistivity of nickel or copper. Platinum must also be sputter-deposited (physical vapor deposition (PVD)) with a maximum deposition thickness on the order of 0.2 micrometers. Copper and nickel can be electroplated to a thickness of several microns making these metal materials more favorable for circuit design considerations. However, these metal materials are easily oxidized at high processing temperatures, such as will be seen in sintering of a ceramic material of the capacitor dielectric. If a reducing atmosphere is used during the sintering of a ceramic to avoid oxidation of an electrode material, the ceramic can be reduced to a conducting (leaky) state. At certain working electric fields (e.g., two volts, 0.1 micron), free charge carriers in the ceramic material generated under a reducing atmosphere can migrate to an electrode causing space charge formation (charge separation), and accompanying Schottky emission of electrons from the cathode (negative electrodes) into the dielectric to maintain a charge neutrality; this process leads to the irreversible increase of leakage current and break-down of the capacitor.

### BRIEF DESCRIPTION OF THE DRAWINGS

Features, aspects, and advantages of embodiments will become more thoroughly apparent from the following detailed description, appended claims, and accompanying drawings in which:

FIG. 1 shows a cross-sectional view of an interposer substrate mounted between a die as a base substrate.

FIG. 2 shows a magnified view of a portion of interposer substrate of FIG. 1.

FIG. 3 shows a flow chart of a method of forming a capacitor.

FIG. 4 shows a graph of the conductivity behavior of a strontium titanate film at various temperatures and oxygen partial pressures. Reference: Integrated Ferroelectrics, 2001, Vol. 38, pp. 229-237, “Defects in alkaline earth titanate thin films—the conduction behavior of doped BST” by Christian Ohly et al.

FIG. 5 shows a cross-sectional view of a die mounted on a base substrate having a capacitor integrated therewith.

### DETAILED DESCRIPTION

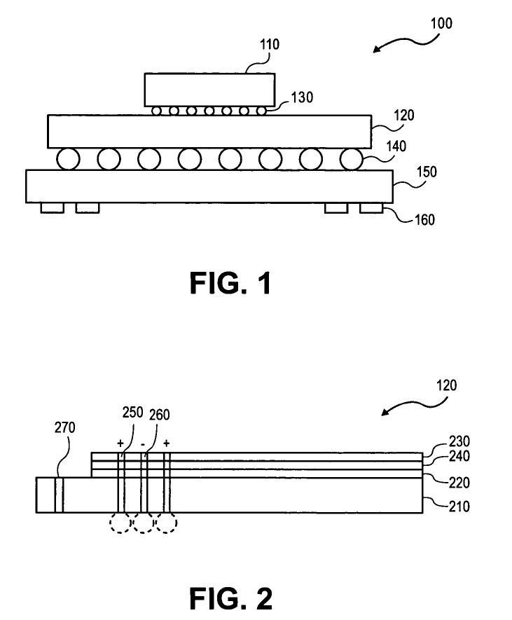

FIG. 1 shows a cross-sectional side view of an interposer substrate mounted between a die and a base substrate. FIG. 1 shows assembly 100 including die or chip 110, interposer substrate 120 and base substrate 150. The assembly may form part of an electronic system such as a computer (e.g., desktop, laptop, hand-held, server, Internet appliance, etc.), a wireless communication device (e.g., cellular phone, cordless phone, pager), a computer-related peripheral (e.g., printer, scanner, monitor), an entertainment device (e.g., television, radio, stereo, tape player, compact disk player, video cassette recorder, MP3 (Motion Picture Experts Group, Audio Layer 3 player) and the like. [00111 In the embodiment shown in FIG. 1, die 110 is an integrated circuit die, such as a processor die. Electrical contact points (e.g., contact pads) on a surface of die 110 are connected to interposer 120 through conductive bump layer 130. Base substrate 150 is, for example, a package substrate, that may be used to connect assembly 100 to a printed circuit board, such as a motherboard or other circuit board. Interposer 120 is electrically connected to base substrate 150 through conductive bump layer 140 that aligns, for example, contact pads on a surface of interposer 120 with contact pads on the surface of base substrate 150. FIG. 1 also shows surface mount capacitors 160 that may optionally be connected to base substrate 150.

In one embodiment, interposer 120 includes a capacitor structure. FIG. 2 shows a magnified view of interposer 120. Interposer 120 includes interposer substrate 210, first conductive layer 220 (electrically conductive) disposed on interposer substrate 210, dielectric layer 240 disposed on first conductive layer 220, and second conductive layer 230 (electrically conductive) disposed on dielectric layer 240. In one embodiment, interposer substrate 210 is a ceramic interposer. Interposer substrate 210 is, for example, a ceramic material having a relatively low dielectric constant. Representatively, a low dielectric constant (low-k) material is a ceramic material having a dielectric constant on the order of 10. Suitable materials include, but are not limited to, a glass ceramic or aluminum oxide (e.g., Al₂O₃).

In one embodiment, first conductive layer 220 and second conductive layer 230 are selected from a material that may be deposited to a thickness on the order of a few microns or more. Suitable materials include, but are not limited to, copper and nickel material. In one embodiment, dielectric layer 240 is a ceramic material having a relatively high dielectric constant (high-k). Representatively, a high-k material is a ceramic material having a dielectric constant on the order of 1000. Suitable materials for dielectric layer 240 include, but are not limited to, barium titanate (BaTiO₃), barium strontium titanate (Ba, Sr) TiO₃, and strontium titanate (SrTiO₃).

In one embodiment, dielectric layer 240 of a high-k ceramic material is formed to a thickness of less than one micron. Representative thicknesses for dielectric layer 240 are on the order of, in one embodiment, 0.1-0.2 micron. A material to form dielectric layer 240 may be deposited as nanometer grains of ceramic materials. Representative grain sizes to deposit a high-k material to a thickness of 0.1 to 0.2 micron are on the order of 20 to 50 nanometers.

FIG. 2 shows a number of conductive vias extending through interposer substrate 120. Representatively, conductive via 250 and conductive via 260 are conductive materials (e.g., copper or silver) of different polarity to be connected to power/ground contact points of chip 110 (e.g., through conductive bumps of bump layer 130 to contact pads on die 110 of FIG. 1). In this manner, conductive via 250 and conductive via 260 extend through a high-k material of dielectric layer 240 and a low-k material of interposer substrate 210. FIG. 2 also shows conductive via 270 (e.g., a copper or silver filled via) adjacent a perimeter of interposer 120. Conductive via 270 is aligned to connect with input/output (I/O) signals. In one embodiment, conductive via 270 does not extend through high-k dielectric layer 240. Representatively, high-k dielectric layer 240 as well as first conductive layer 220 and second conductive layer 230 are etched away in the perimeter of interposer 120 to remove the high-k material from the conduction path of conductive via 270.

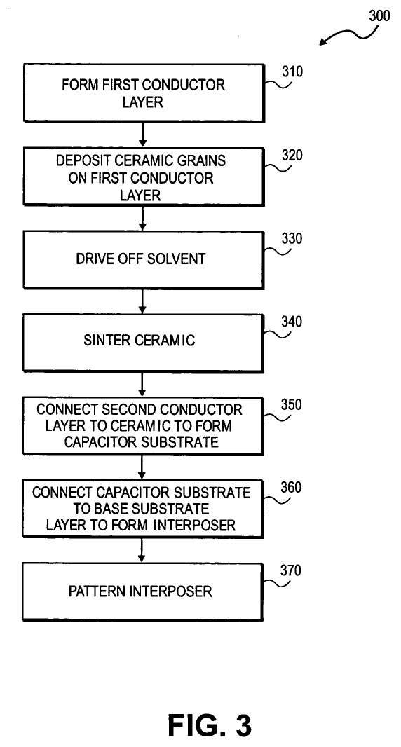

FIG. 3 shows one technique for forming interposer 120. Referring to FIG. 3, method or technique 300 includes initially forming a first conductive layer at block 310. Representatively, a first conductive layer, such as first conductive layer 220 of FIG. 2 is a nickel or copper material that is formed as a sheet (e.g., foil) having a desired thickness. Representative thicknesses are on the order of several microns to tens of microns depending on the particular design parameters. One way a conductor layer of sheet or foil may be formed is by electroplating a material foil or layer on a removable base substrate (e.g., a polymer carrier sheet) having, for example, a conductive seed layer on a surface thereof. Alternatively, a conductive material paste (e.g., copper or nickel paste) may be deposited on the removable base substrate.

Following the formation of the first conductive layer or the deposition of a first conductive layer, technique or method 300 provides depositing ceramic grains on a surface, including the entire surface, of the first conductive layer, block 320. To form a ceramic material of a thickness on the order of 0.1 to 0.2 micron, ceramic grains having a thickness on the order of 20 to 30 nanometers are deposited on the first conductive layer. One way to deposit ceramic material is through a chemical solution deposition (e.g., sol-gel) process where the metal cations are embedded in polymer chains which are dissolved in a solvent, and the solvent spun or sprayed on to the first conductive layer. Another technique for depositing ceramic material is by chemical vapor deposition (CVD).

Referring to technique or method 300 of FIG. 3, in the embodiment where ceramic material is deposited through a solvent, such as in a sol gel process, once deposited, the deposits are dried to burn-off organic contents, block 330. Representatively, the first conductor layer having deposited ceramic grains thereon is exposed to an inert atmosphere (e.g., nitrogen) and an elevated temperature (e.g., 100 to 200° C.) to drive off the solvent and remove organic contents.

The ceramic grains are exposed to a sintering process to reduce the surface energy of the ceramic particles, block 340. In an embodiment where an oxidizable metals such as copper or nickel is utilized as a conductor layer, process conditions are selected so as not to oxidize the conductor layer. For a conductor layer of copper or nickel, for example, processing parameters including a reducing atmosphere are utilized so that the copper or nickel material of the first conductor layer is not oxidized. The presence of a reducing atmosphere, however, tends to reduce the ceramic material tending to make the ceramic material more conductive (a more leaky state). Thus, processing parameters are selected that control the oxidation of the conductor layer and the reduction of a ceramic material. In an alternate process flow, sintering of high-k film, block 340, can be accomplished after the deposition of a second conductor layer on the ceramic material. Representatively, one or both of the first conductor layer and the second conductor layer are formed from a metal paste. In the case of the second electrode being formed from a metal paste, the metal paste may be deposited on the ceramic material prior to sintering.

In one embodiment, a ceramic material such as barium titanate (BaTiO₃), strontium titanate (SrTiO₃), or barium strontium titanate (Ba,SrTiO₃) includes immobile ions (Ba, Sr, Ti) and mobile ions (O). A typical ceramic material (e.g., grains, crystals) may also have a number of point defects largely attributable to ionic vacancies and free electronic carriers, such as electrons in a conduction band and holes in a valence band. Concentrations of mobile free electrons and oxygen vacancies increase under the typical sintering conditions including elevated temperature and reducing atmosphere. Using the example of oxygen in a reducing atmosphere including oxygen gas, in one embodiment, a chemical potential of oxygen in a reducing gas is selected in such a way that the equilibrium conductivity of the ceramic reflects a favorable regime in a corresponding Kröger-Vink diagram. In this manner, the tendency for an oxygen ion to move from a solid state to a gas with the concomitant transfer of electrons from a valance band to a conduction band will be controlled. Where an oxidizable metal such as copper or nickel is used as an electrode and exposed to the sintering process conditions, the processing conditions must be further controlled to minimize the oxidation of the electrode.

In order to determine the particular processing parameters to sinter the ceramic material, the equilibrium conductivity of the ceramic material as a function of thermodynamic state parameters (temperature (T), partial pressure of oxygen (P(O₂), ceramic composition-fixed for a given sample, assuming zero volatility) is obtained for a sample of ceramic material. Representatively, a four point conductivity measurement of a ceramic material sample may be analyzed at various sintering temperatures and pressures, with the conductivity measured at an equilibrium state.

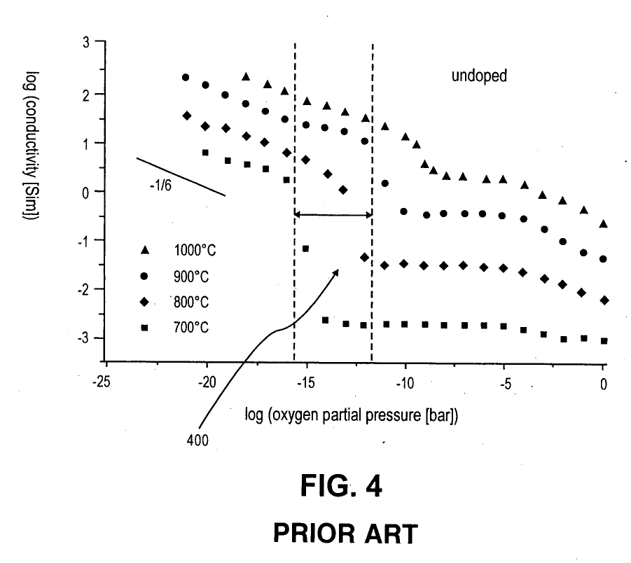

FIG. 4 shows the representative conductivity behavior of a nominally undoped strontium titanate (SrTiO₃) thin film. The data points, such as in FIG. 4, provide an indication of the amount and type of point defects that exist in the ceramic material at each thermodynamic equilibrium point. This thermodynamic state function (function of T, P(O₂), and ceramic material) may be utilized to determine a conductivity state transition from a dielectric state to a conductive state. As shown in FIG. 4, at a sintering temperature of 700° C., the conductivity state transition for SrTiO₃ occurs at approximately 1×10⁻¹⁵ bar. To effectively function as a dielectric material, suitable for use in a decoupling capacitor, the ceramic material must be sintered at a pressure greater than 1×10⁻¹⁵ bar (to the right on the graph of FIG. 4).

In addition to determine a conductivity phase transition for a desired sintering temperature, the limiting value of the reducing atmosphere for an oxidizable metal is determined. In one example using a metal such as copper in a reducing atmosphere of oxygen, the limiting value of P(O₂) for metallic copper is determined from the Gibbs free energy expression for the oxidation reaction of copper as given by the following equation:

$$\begin{matrix}4 Cu + {O}_{2} = 2 {Cu}_{2} O \\ Δ G = - 333 \text{,} 000 + 126 T \\ = RT ln P ( {O}_{2} ) .\end{matrix}$$

Using the above equation, for a sintering temperature of 700° C., the P(O₂) value is about 5×10⁻¹² bar. The P(O₂) of the reducing gas in a sintering furnace needs to be lower than about 5×10⁻¹² bar to inhibit the oxidation of copper in a reducing atmosphere. However, as noted above, the conductivity phase transition is around 1×10⁻¹⁵ bar. Hence, for a sintering temperature 700° C., a partial pressure of oxygen in a reducing atmosphere is a processing window between about 5×10⁻¹² bar and 1×10⁻¹⁵ bar (illustrated by arrow 400 in FIG. 4).

The above example demonstrates that there is a range (a sweet spot) of processing conditions of temperature and pressure for sintering a high-k ceramic material without oxidizing a metal such as copper or nickel and without creating a leaky ceramic material.

Referring to FIG. 3, following the sintering of the ceramic material, a second conductor layer may be connected (e.g., printed, electroplated) to the ceramic material to form a capacitor substrate, block 350. In the embodiment where the ceramic overlies a sheet or foil of the first conductor layer, the second conductor layer may be disposed on an opposite surface of the ceramic material. In one embodiment, the second conductor layer is a metal such as nickel or copper. As noted above, in an alternate process, the second conductor layer is formed on the ceramic material prior to sintering the ceramic material.

The capacitor substrate may then be connected (e.g., laminated) to an interposer substrate layer to form an interposer, block 360. In one embodiment, the interposer substrate layer is a ceramic material. Representatively, the interposer substrate layer is a ceramic material having a relatively low dielectric constant while the ceramic material of the composite capacitor has a relatively high dielectric constant.

Following the connection of the capacitor substrate to the interposer substrate layer, to form a ceramic interposer, the interposer is patterned, block 370. In one embodiment, the interposer is patterned by forming vias through the interposer, removing high-k ceramic material from the peripheral region, etc.

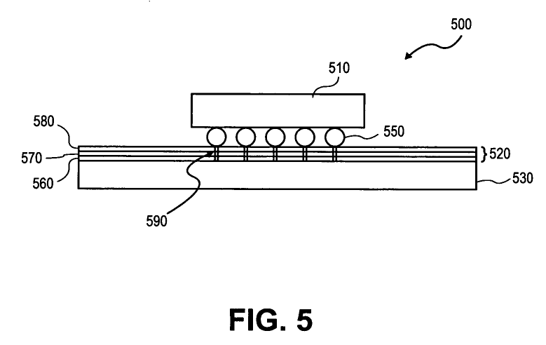

FIG. 5 shows another embodiment of a die or chip assembly. Assembly 500 includes die or chip 510 connected to package substrate 530. Package substrate 530 has integrated therewith capacitor 520. Capacitor 520 is similar to the capacitor element of interposer 120 described above with reference to FIGS. 1 and 2. Notably, capacitor 520 includes first conductor layer 560, dielectric layer 570, and second conductor layer 580 each in the form a sheet with dielectric layer 570 disposed between first conductor layer 560 and second connector layer 580. In one embodiment, capacitor 520 may be formed as described above with reference to FIG. 3 utilizing a first conductor layer 560 and second conductor layer 580 of a metal such as copper or nickel and a relatively high dielectric constant (high-k) ceramic material as dielectric layer 570. The method for forming capacitor 520 may follow the method in FIG. 3 with the capacitor being connected to package substrate 530 after formation rather than being connected to an interposer. FIG. 5 shows conductive vias 590 extending through capacitor 520. Conductive vias 590 are connected to bumps 550 that are aligned with contact pads on, in one embodiment, chip or die 510.

In the preceding detailed description, reference is made to specific embodiments thereof It will, however, be evident that various modifications and changes may be made thereto without departing from the broader spirit and scope of the following claims. The specification and drawings are, accordingly, to be regarded in an illustrative rather than a restrictive sense.

1. A method comprising:
forming a capacitor structure comprising an electrode material and a ceramic material on the electrode material; and
sintering the ceramic material an oxygen partial pressure selected where a point defect state of a thin film of the ceramic material defines the ceramic material as insulating without oxidation of the electrode material.

2. The method of claim 1, wherein the condition comprises an elevated temperature and a reducing atmosphere.

3. The method of claim 1, wherein the electrode material is selected from a copper material and a nickel material.

4. The method of claim 2, wherein the ceramic material comprises oxygen and the reducing atmosphere comprises an oxygen gas and the condition comprises a chemical potential of the oxygen in the ceramic material such that a thermodynamic state of the ceramic material corresponds to a selected regime in the corresponding Kröger-Vink diagram.

5. The method of claim 1, wherein the ceramic material has a thickness on the order of less than one micron.

6. The method of claim 1, wherein the electrode material is a first electrode material and after sintering the ceramic, the method further comprises:
coupling a second electrode material to the ceramic material.

7. The method of claim 1, wherein the electrode material is a first electrode material and prior to sintering the ceramic material, the method comprising:
depositing a second electrode material on the ceramic material.

8. A method comprising:
depositing a ceramic material on an electrically conductive foil; and
sintering the ceramic material in a reducing atmosphere at an oxygen partial pressure that minimizes the mobility of point defects in a thin film to transition to a level corresponding to a greater conductivity of the ceramic material.

9. The method of claim 8, wherein the electrically conductive foil comprises one of a copper material and a nickel material.

10. The method of claim 9, wherein the oxygen partial pressure of the reducing atmosphere is selected that minimizes the potential for oxidation of the conductive foil.

11. The method of claim 8, wherein the ceramic material has a thickness on the order of less than one micron.

12. The method of claim 8, wherein the electrically conductive foil comprises a first electrically conductive foil and after sintering the ceramic material, the method further comprises:
coupling a second electrically conductive foil to the ceramic material such that the ceramic material is disposed between the first electrically conductive foil and the second electrically conductive foil.

13. The method of claim 8, wherein the electrically conductive foil comprises a first electrode material and prior to sintering the ceramic material, the method comprising:
depositing a second electrode material on the ceramic material.

14-16. (canceled)
